(19) United States
(12) Patent Application Publication
(10) Pub. No.: US 2015/0288675 A1
(43) Pub. Date: Oct. 8, 2015

(54) SYSTEM, METHOD FOR COMPUTER SECURITY

(71) Applicant: Kabushiki Kaisha Toshiba, Tokyo (JP)

(72) Inventors: Nicholas G.H. BURKE, San Francisco, CA (US); Joshua LINDSAY, Woodside, CA (US)

(73) Assignee: Kabushiki Kaisha Toshiba, Tokyo (JP)

(21) Appl. No.: 14/243,132

(22) Filed: Apr. 2, 2014

(51) Int. Cl. H04L 29/06

(52) U.S. Cl. CPC H04L 63/083; H04L 63/10

(57) ABSTRACT

A networked device comprises a network interface, a control module, and an enabling module. The enabling module is configured to detect a request to enable the control module. In response to detecting the request and determining that the request is received through a physically secure channel, the enabling module enables the control module and sets up credentials for accessing the control module.

### BACKGROUND

It is common practice for a computer hardware vendor to ship an unconfigured computing device to a purchaser, where the purchaser configures the device at home at some later time. Indeed, the practice is becoming more common outside the realm of traditional desktop and laptop computers. More and more home appliances, automobiles, and the like include on-board processing units that enable the appliance or car to perform a multitude of services, ranging from providing remote access to an end user, to performing operations based on an internal timer or scheduler.

Most computing devices, whether they are traditional computers or “smart” appliances, require some additional configuration when an end user begins using the device. In order to configure a computing device, particularly a device complex enough to support the execution of an operating system, certain administrative privileges are usually required. Administrative privileges are often required to install hardware, device drivers, and to enable and start up certain processes on the device. In order to ensure that an end user who attempts to configure the device has proper administrative rights to do so, most devices support the establishment of administrative accounts. One such account is the “root” account included with the Unix operating system. In order to use such an administrative account, an end user must log into the account, typically with a password. However, this password is often configured by the vendor as a “default” password and communicated to the end user by e-mail or by printing the password on a piece of paper shipped with the device.

Needless to say, such methods for providing access to a user to perform administrative tasks on a computing device have proven insecure. E-mailed and printed passwords are easily intercepted and learned by computer hackers. Indeed, such “default” passwords are often consolidated and published on the World Wide Web. Thus, a need has arisen to allow consumers to perform configuration tasks on computing devices in a secure fashion without the need for communicating administrative passwords in an unsecure fashion.

### SUMMARY OF THE DISCLOSURE

In a first embodiment, a networked device is provided. The networked device comprises a network interface, a control module, and an enabling module. The enabling module is configured to detect a request to enable the control module, and , in response to detecting the request and determining that the request is received through a physically secure channel, to enable the control module and set up credentials for accessing the control module.

In a second embodiment, a method of enabling a control module of a networked device is provided. The method comprises the step of detecting a request to enable the control module. Further, the method comprises, in response to detecting the enable request, determining that the request is received through a physically secure channel, setting up credentials for accessing the control module, and enabling the control module.

In a third embodiment, a method of resetting a password for a control module that is enabled for a networked device is provided. The method comprises the steps of detecting a request to disable the control module and determining that the request is received through a physically secure channel. The method further comprises the steps of disabling the control module and detecting a request to enable the control module. Further, the method comprises issuing a prompt to create a new password for the control module, receiving and storing the new password, and enabling the control module.

### BRIEF DESCRIPTION OF THE DRAWINGS

FIG. 1 is a block diagram illustrating a networked environment in which embodiments may be implemented.

FIG. 2 is a block diagram illustrating a second networked environment in which embodiments may be implemented.

FIG. 3 is a flow diagram that illustrates a method for enabling a control module over a physically secure network connection, according to one or more embodiments.

FIG. 4 is a flow diagram that illustrates a method of accessing a networked device through a control module, according to one or more embodiments.

FIG. 5 is a flow diagram that illustrates a method for resetting a password for a control module that is already enabled for a networked device, according to one or more embodiments.

### DETAILED DESCRIPTION

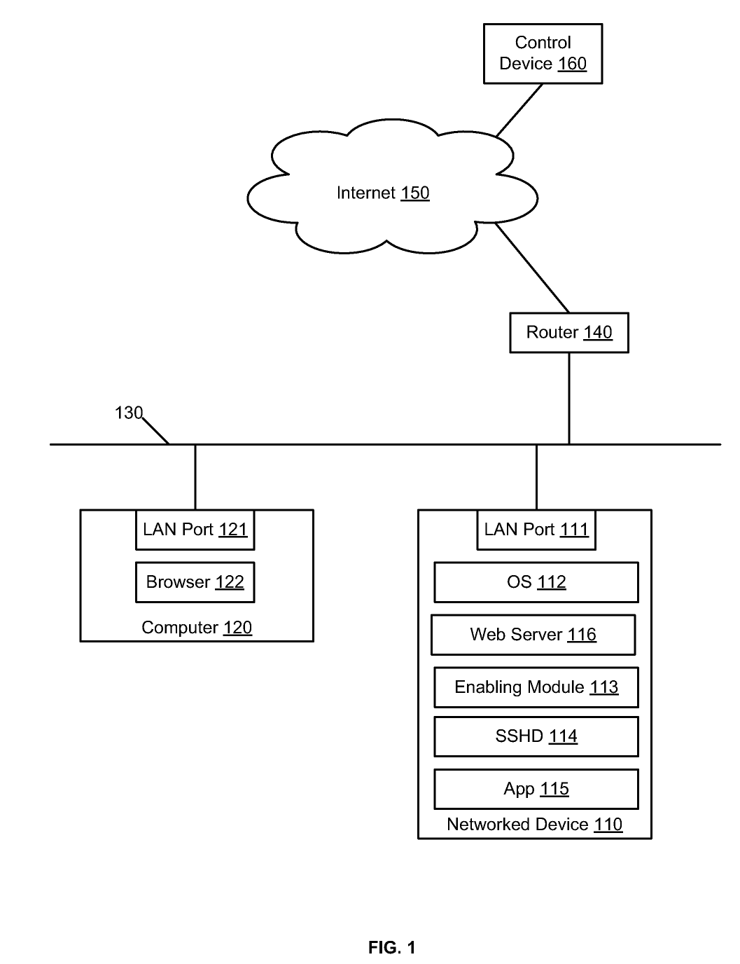

FIG. 1 is a block diagram illustrating a networked environment in which embodiments may be implemented. Local area network (LAN) 130 is a computer network that is configured to interconnect computers in a limited area, such as a home, laboratory, office, or classroom. Typically, embodiments of the present invention are implemented using a home LAN, although the invention is not strictly limited to such a LAN. LAN 130 may be any type of wired LAN, such as, for example, Ethernet or Token Ring. LAN 130 may be cabled using coaxial cabling, twisted pair (shielded or unshielded), optical fiber, or any other medium that supports the transmission of data signals over a LAN. FIG. 1 depicts a bus configuration, although the invention may be implemented using other network topologies, such as a ring, mesh, or star configuration. Data communication protocols supported by LAN 130 include, but are not limited to, TCP/IP, IPX/SPX, NetBIOS, and AppleTalk.

LAN 130 is implemented to provide for physically secure network connectivity. That is, LAN 130 is physically isolated, and devices connected to LAN 130 connect over a physical network adapter directly to the physical medium (i.e., cable) that comprises the LAN. Thus, embodiments of LAN 130 tend not to be wireless LANs (i.e., WiFi networks). As shown in FIG. 1, a computer 120 is connected to LAN 130 through a LAN port 121. Computer 120 may be a conventional desktop computer, workstation, or server. Alternatively, computer 120 may be a laptop, notebook, or tablet computer. Computer 120 is configured with a certain amount of RAM and has conventional input/output devices to faciliate user interaction, such as a keyboard, mouse, and monitor. Computer 120 may run an operating system (such as Windows, Linux, or MacOS), and may have one or more applications running under the operating system's control. Computer 120 may also be configured to include a persistent external storage device (such as a hard disk drive), or it may be configured as a diskless workstation that loads software from an external disk storage device that is also connected to LAN 130. As shown in FIG. 1, among the applications that run on computer 120 is a browser 122. Browser 122 has functionality to establish a connection with a server that is connected to LAN 130, or connected to an external network. After such a connection is established, browser 122 allows an end user to communicate with the server. In embodiments, browser 122 is a web browser (such as Internet Explorer or Firefox) that allows an end user to communicate with a web application that is running on a web server, or to access web content residing on the web server. In embodiments, computer 120 communicates with a web server via browser 122 using an application-layer protocol, such as Hypertext Transfer Protocol (or HTTP). In other embodiments, browser 122 is a dedicated program that communicates with some server process using a proprietary protocol.

As shown in FIG. 1, computer 120 connects to LAN 130 via LAN port 121. In embodiments, LAN port 121 is a traditional Ethernet adapter implemented as a convention PCI card (for desktop computers), or as a PCMCIA adapter (for laptop computers). Further, LAN port 121 may be implemented as an integrated chip and pre-installed inside computer 120.

Also depicted in FIG. 1 is a networked device 110. In general, networked device 110 may be any type of programmable device that is capable of connecting LAN 130 and of executing an operating system and application programs therein. Networked devices, as described herein, are usually configured to perform a discrete set of functions. This stands in contrast with general purpose computers, which are programmed to perform any of a large number of tasks. Examples of networked devices are smart appliances. For example, an oven may be equipped with an on-board computing device that allows it to be controlled remotely over a network. Another example is a Bluetooth-compatible car stereo. Networked devices are also present in industrial settings. For example, a gas turbine may be outfitted with dedicated processors that are configured to monitor and detect certain events, to execute certain functions at set times, and to collect statistics that may be analyzed remotely by field engineers.

In one or more embodiments, networked device 110 is a Network Attached Storage Device (or NAS). NAS devices are typically file-level computer data storage devices that connect to a computer network and provide data access to a heterogeneous group of clients. NAS devices may operate as file servers, and are often specialized for such a task either by a specific hardware or software configuration. NAS devices often provide for faster data access, easier administration, and simpler configuration than do general purpose computers.

As shown in FIG. 1, networked device 110 connects to LAN 130 over LAN port 111. LAN port 111 provides the same functionality and LAN connectivity for networked device 110 as LAN port 121 provides for computer 120. Thus, LAN port 111 may be implemented using any one of the several devices that may be used for LAN port 121.

Further, an operating system (OS) 112 runs within networked device 110. In embodiments, OS 112 may be any of the well-known server operating systems, such as Unix, Linux, Windows Server, or OS X Server. In addition to OS 112, networked device 110 also runs one or more applications 115. Applications 115 range from file sharing applications running on NAS devices to appliance- and industry-specific applications running on smart appliances.

In the embodiment shown in FIG. 1, networked device 110 also runs a web server 116. An example of web server 116 is Apache HTTP server. However embodiments of networked device 110 may be configured to execute any web server capable of receiving and responding to http requests. In FIG. 1, browser 122 running on computer 120 issues http requests over LAN 130 to networked device 110. The http requests are received and processed by web server 116.

In addition, as shown in FIG. 1, networked device 110 runs a Secure Shell daemon (or SSHD) 114. SSH is an encrypted network protocol for data communication, remote command-line login, remote command execution, and other network services between two networked computers. The networked computers are able to communicate via an encrypted channel over an unsecure network. A typical use for SSH is for accessing shell accounts on Unix and Unix-like operating systems, although, in embodiments, SSH may be used to access Windows shell accounts. Encryption used by SSH is intended to provide confidentiality and data integrity over an unsecured network, such as the Internet. In TCP/IP networks (such as the Internet), the standard TCP port assigned for SSH servers is port 22. An SSH client program is typically used for establishing connections to an SSH daemon that accepts remote connections. An SSH daemon is commonly included on a variety of operating systems, such as Mac OS X, and most versions of Linux, Solaris and OpenVMS. In order to connect to a target computer via SSH, the secure shell daemon must be present and running on the target computer.

Networked device 110 includes SSHD 114 (i.e., the secured shell daemon), which enables a remote user to open and access a shell on the networked device. However, in embodiments, SSHD 114 does not start automatically when networked device 110 starts. Further, implementations of SSH support password-based authentication. That is, an end user who wishes to access a shell on a networked device through SSH must connect with a running instance of the SSH daemon and, for devices that use password authentication, provide a password to the SSH daemon. In embodiments, the SSH daemon typically uses the password services of the operating system on which the daemon executes in order to authenticate the user-provided password. Thus, in order for a remote user to access a networked device through SSH using a password, SSH must be enabled and running, and an SSH password must be set.

As shown in FIG. 1, networked device 110 also includes an enabling module 113. Enabling module 113 is a software module that, when executed, configures networked device 110 by allowing an end user to set a password for a particular service on the networked device, and to start the service as a running process on the networked device. Thus, with respect to SSHD 114, enabling module 113 provides means for an end user to set a password for SSHD 114 (i.e, the password to be used by an end user who wishes to connect to networked device 110 through SSH). Once a password has been set for SSHD 114, enabling module 113 automatically starts SSHD 114 (i.e., the SSH daemon on networked device 110). Further, in some embodiments, enabling module 113 enables a login account (e.g., a root login or some other administrative login account) that an end user logs into through the secured shell interface.

In embodiments, enabling module 113 is accessible only over a physically secure network connection. That is, in the embodiment shown in FIG. 1, an end user who wishes to access enabling module 113 may only do so from a device that is only connected to LAN 130. LAN 130, as previously mentioned, provides a physically secure network connection to networked device 110 because networked device 110 is physically connected to LAN 130 through LAN port 111. Further, as shown in FIG. 1, computer 120 is physically connected to LAN 130 through LAN port 121. Both networked device 110 and computer 120 are in close physical proximity with each other and with LAN 130. Further, LAN 130 is physically isolated. Thus, a user of computer 120 may access networked device 110 through a physically secure network connection. In embodiments, such a user accesses browser 122 to send http requests over LAN 130 to web server 116 on networked device 110. Web server 116 then processes the request and serves content (in the form of a web page) to browser 122. The user of computer 120 then issues administrative requests to enable SSHD 114 through browser 122 in order to both set the password for SSHD 114, and to start SSHD 114 once the password has been set. In order to accomplish this, web server 116 processes the incoming administrative requests from browser 122 and forwards these requests to enabling module 113. Enabling module 113 then sets the password for SSHD 114 as specified by the end user and, after setting the password, starts SSHD 114.

Enabling module 113 is also configured to disable SSHD 114. To disable SSHD 114, enabling module 113 receives a request over a physically secure network connection, in much the same way that the aforementioned enabling request is received. That is, an end user accessing computer 120 (which is connected to LAN 130) sends a disable request to networked device 110. The disable request is processed by web server 116 and forwarded to enabling module 113. Enabling module 113 then disables SSHD 114 by, in some embodiments, issuing a command (such as the Unix kill command) to end the thread that runs SSHD 114. It should be noted that, after SSHD 114 is disabled, SSHD 114 may be subsequently re-enabled through another enable request in the same manner as set forth above. When SSHD 114 is disabled, embodiments of the present invention do not preserve the previously set password. This behavior protects SSH users of SSHD 114 from being locked out of networked device 110 in the event that the password is forgotten. Thus, when SSHD 114 is disabled and subsequently re-enabled, a new password is provided with the subsequent enable request.

Further, in embodiments, enabling module 113 is configured to check the strength of a password before setting that password for SSHD 114. For example, enabling module 113 may be configured to recognize certain common words or keystroke sequences, or to enforce password length and character restrictions prior to setting any password for SSHD 114. Once enabling module 113 determines that a password meets all requirements that enabling module 113 was configured to verify, then enabling module 113 sets the verified password for SSHD 114.

Referring again to FIG. 1, router 140 is also connected to LAN 130. Router 140 provides connectivity between devices connected directly to LAN 130 and devices that are connected to external networks. For example, as shown in FIG. 1, router 140 is connected to Internet 150. Internet 150 is an external backbone network that has connectivity to the global Internet. In addition, embodiments of router 140 are also configured to support wireless network connections via an external WiFi network. Using such a connection, end users that use computers having wireless adapters configured therein may connect to resources on LAN 130 through wireless connectivity features of router 140.

In addition, FIG. 1 depicts control device 160, which is connected to Internet 150 (i.e., the backbone network that is external to LAN 130). Similar to computer 120, control device 160 may be a standard desktop or laptop computer. Further, control device 160 may be a smartphone. A user of control device 160 accesses Internet 150 in order to establish a connection with resources on LAN 130, specifically, with networked device 110. In embodiments, control device 160 connects over Internet 150, through router 140 and LAN port 111, to access SSHD 114 in order to open a shell on networked device 110. After opening a shell through an SSH connection to networked device 110, and end user using control device 160 may perform various shell-oriented (i.e., command line) tasks on networked device 110. It should be noted that, in order to establish an SSH connection from control device 160 to networked device 110, control device 160 must be configured with an SSH client. The end user of control device 160 must also provide the SSH password set by the user of computer 120 (who set the password using enabling module 113). In this way, control device 160 may open and maintain a secure shell connection over an unsecure network (i.e., via Internet 150).

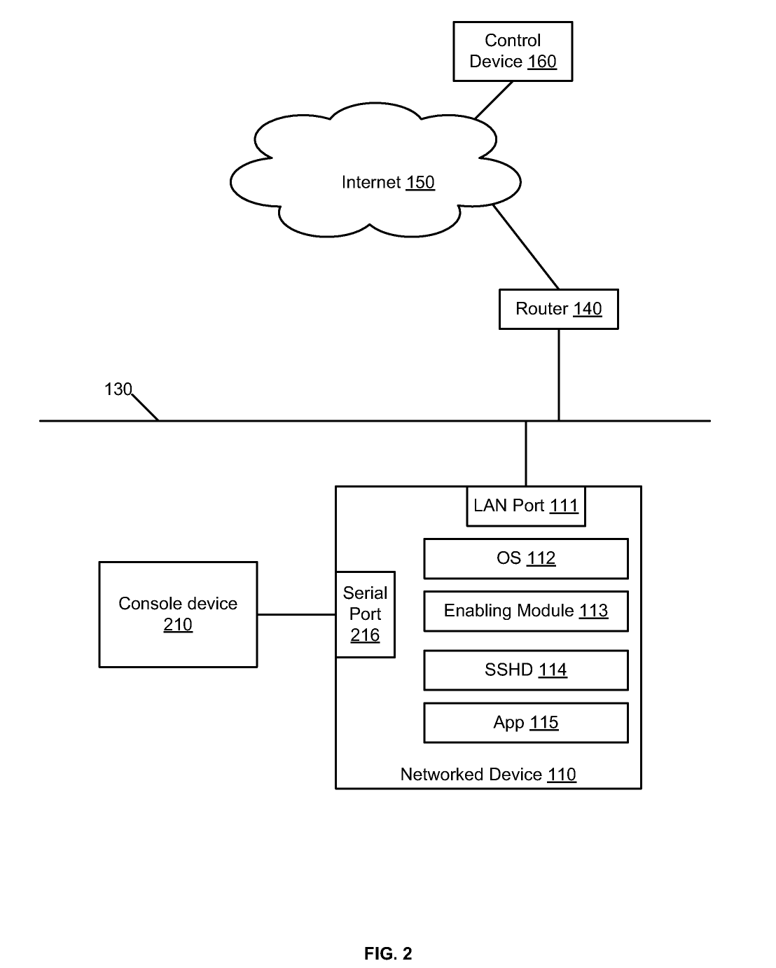

FIG. 2 is a block diagram illustrating a second networked environment in which embodiments may be implemented. As is the case for FIG. 1, FIG. 2 depicts LAN 130. Router 140 is physically connected to LAN 130 and has the same characteristics as the router depicted in FIG. 1. Router 140 provides connectivity between LAN 130 and Internet 150. As in FIG. 1, Internet 150 is an external unsecure backbone network. Control device 160 connects to Internet 150. An end user that uses control device 160 may access resources on LAN 130 by connecting to those resources through Internet 150 and router 140. Among the resources connected to LAN 130 is networked device 110.

Networked device 110 depicted in FIG. 2 has many of the same features present in the networked device 110 depicted in FIG. 1. In FIG. 2, networked device 110 runs an OS 112, an SSHD 114, and one or more Applications 115. Networked device 110 also includes an enabling module 113. As is the case for the embodiment of FIG. 1, enabling module 113 is a software module that, when executed, configures networked device 110 by allowing an end user to set a password for one or more services that run on networked device 110 and, once the password is set, to start said services as one or more processes that run on the networked device. It should be noted that, as previously mentioned, embodiments of enabling module 113 only process requests that are received over a secure network connection.

Further networked device 110 is physically connected to LAN 130 through LAN port 111. However, in the embodiment of FIG. 2, networked device does not include a web server. Rather, networked device 110 in FIG. 2 is configured with serial port 216. In embodiments, serial port 216 is a conventional serial communication interface through which data flows one bit at a time. As shown in FIG. 2, a console device 210 connects directly to serial port 216. Console device 210, in embodiments, is a conventional desktop, laptop, or portable computing device. Console device 210 has a data entry means (such as a keyboard or mouse) through which an end user may enter data. Console device 210 also has a conventional display. Console device 210 is configured with a serial port of its own (not shown), which is connected directly to serial port 216 on networked device 110. It should be noted that the connection from console device 210 to networked device 110 over serial port 216 is a physically secure network connection because console device 210 and serial port 216 are in close physical proximity (i.e., on the same secure physical premises).

Thus, in this way, an end user using console device 210 may transmit administrative requests to serial port 216 over a physically secure network connection. Networked device 110 processes these administrative requests received over the serial port. Among the requests that networked device 110 receives and processes are requests to enable SSHD 114. Such requests are routed to enabling module 113, which, in embodiments, is configured to start SSHD 114. In embodiments where SSHD 114 runs with password-based authentication, console device 210 also transmits an initial password to serial port 216. As was the case for the embodiment of FIG. 1, enabling module 113 receives and sets the initial password for SSHD 114. This password serves as the SSHD password that an end user of control device 160 would require in order to open an SSH connection to networked device 110. Further, in the embodiment of FIG. 2, enabling module 113 is also configured to accept requests to disable SSHD 114 that are transmitted over serial port 216. In some embodiments, enabling module 113 is also configured to check the strength of a received password according to certain password restrictions that enabling module 113 is configured to enforce.

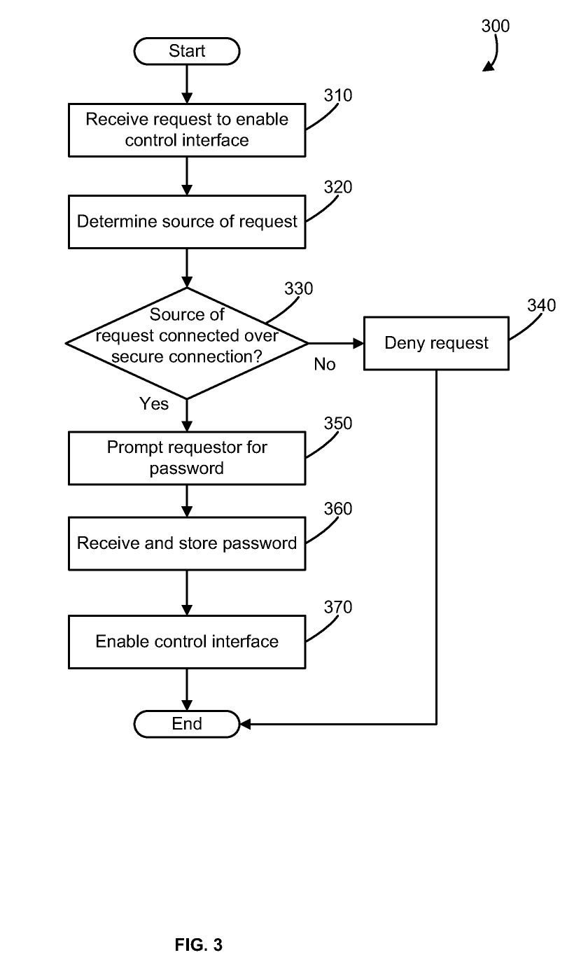

FIG. 3 is a flow diagram that illustrates a method 300 for enabling a control module over a physically secure network connection, according to one or more embodiments. Method 300 is typically performed by an enabling module that runs on a networked device, much like the components depicted in FIGS. 1 and 2.

Method 300 begins at step 310, where the enabling module receives a request to enable a control module. In embodiments, the control module is an SSH daemon, which allows end users to open a secure shell on the networked device over an unsecure network connection. Next, at step 320, the enabling module determines the source of the request received at step 320. As shown in FIGS. 1 and 2, a request may arrive over a physically secure LAN connection , over a serial port, or over an unsecure network connection. At step 330, the enabling module determines whether the request was received over a physically secure network connection. As previously mentioned, physically secure network connections include connections to the networked device from a source that is in close physical proximity to the networked device over a network that is physically isolated (e.g., a home LAN). Devices are in close physical proximity when they are directly connected to the same physically isolated LAN or if they are connected directly to each other, such as through serial ports. Thus, as shown in FIG. 1, a local LAN connection from computer 120 to networked device 110 over LAN 130 is considered a physically secure network connection. Further, referring to FIG. 2, a connection from console device 210 to networked device 110 over serial port 216 is considered a physically secure network connection. However, a connection from control device 160 over Internet 150 would not be considered a physically secure network connection because control device 160 is remote from networked device 110, and may access networked device 110 only through router 140.

Referring back to FIG. 3, if the enabling module determines that the request to enable the control module is not received over a physically secure network connection, the enable request is denied at step 340 and method 300 then terminates. However, if the enabling module determines that the enable request was received over a physically secure network connection, then method 300 proceeds to step 350.

At step 350, the enabling module prompts the requestor to enter a password. As previously mentioned, the requestor may transmit an enabling request using an interface, such as a browser or custom interface. In embodiments, the requestor may enter a password and transmit the password back over the physically secure network connection to the enabling module.

At step 360, the enabling module receives and stores the password entered by the requestor. Further, in some embodiments, the enabling module may be configured to check the strength of the received password according to one or more password rules. After step 360, method 300 proceeds to step 370, where the enabling module enables the control module. In one or more embodiments, the enabling of the control module entails the starting of one or more processes on the networked device. In particular, with respect to FIGS. 1 and 2, the enablement of the control module entails starting an SSH daemon (i.e., SSHD 114) on the networked device. In addition, in some embodiments, the enabling module enables a login account (such as a root login or administrative account) that an end user may log into the networked device using the enabled control module.

Once the control module is enabled at step 370, method 300 terminates.

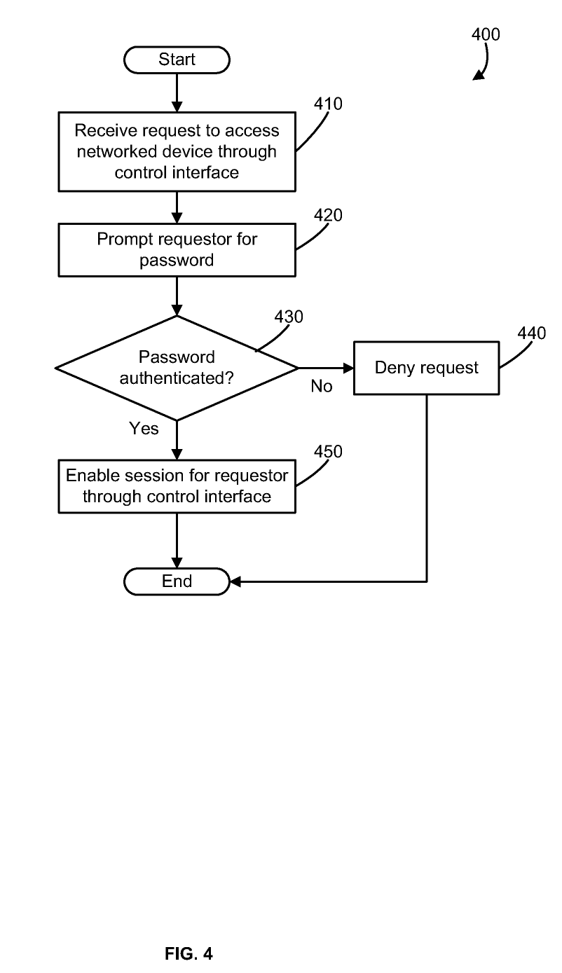

FIG. 4 illustrates a method 400 of accessing a networked device through a control module, according to one or more embodiments. The method is typically executed by the control module enabled in method 300 depicted in FIG. 3. Method 400 begins at step 410, when a request to access the networked device through the control module is received. In the embodiments depicted in FIGS. 1 and 2, the control module is an SSH daemon (i.e., SSHD 114), while the requestor is an end user that uses control device 160 connected to Internet 150.

Once the request to access the networked device is received, the control module prompts the requestor for a password at step 420. At step 430, the control module determines whether the password is successfully authenticated. Authentication of the password is performed by comparing the password provided by the requestor with the password received and stored at step 360 of method 300.

If, at step 430, the password fails authentication, then method 400 proceeds to step 440, where the access request is denied. After denial of the request, method 400 terminates. However, if the password is successfully authenticated at step 430, then method 400 proceeds to step 450. At step 450, the control module enables a session for the requestor to access the networked device through the control module. In the embodiments depicted in FIGS. 1 and 2, enablement of the session entails starting a secure shell for the requestor so that the end user at control device 160 may communicate with the networked device through the shell (i.e., through a command line interface). Thus, in this way, a user may open a secure shell session with a networked device over an unsecure network.

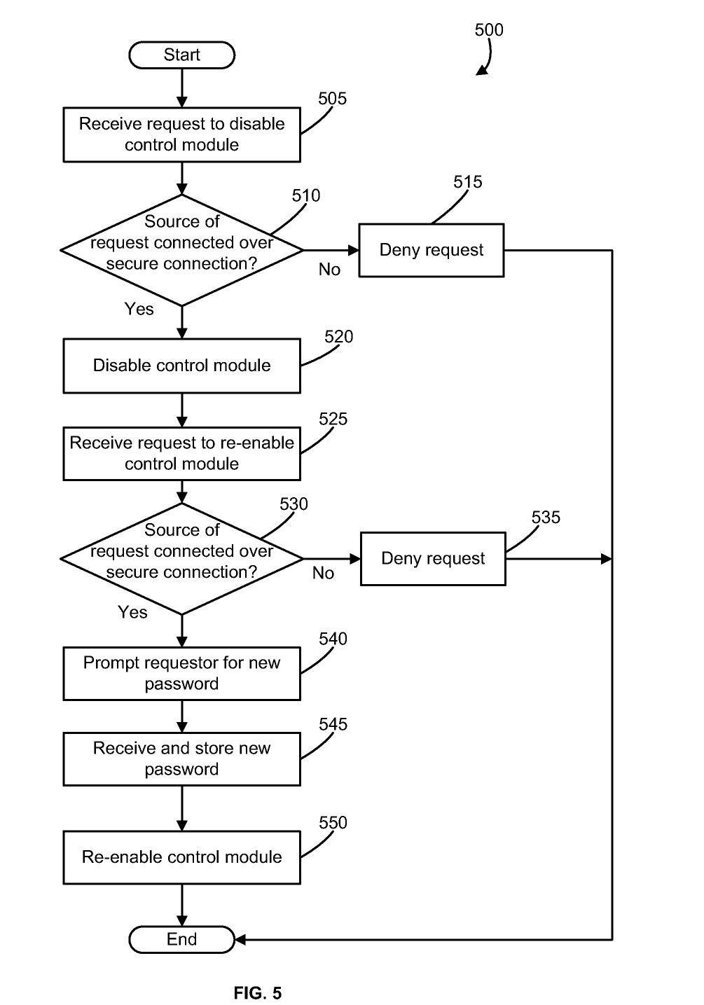

FIG. 5 is a flow diagram that illustrates a method 500 for resetting a password for a control module that is already enabled for a networked device, according to one or more embodiments. Method 500 is typically performed by an enabling module, such as enabling module 113 described in FIGS. 1 and 2. Method 500 begins at step 505, where the enabling module receives a request to disable the control module. At step 510, the enabling module determines whether the disable request was received from a source that is connected to the enabling module over a physically secure network connection. As previously mentioned, an example of a physically secure network connection is a connection between two computing devices that are physically connected to the same isolated LAN and are in close proximity to each other. An illustration of this sort of physically secure network connection appears in FIG. 1, where computer 120 and networked device 110 are each physically connected to LAN 130. Another example of a physically secure network connection between two computing devices is the case where the computing devices are connected directly to each other. An illustration of this sort of physically secure connection appears in FIG. 2, where console 210 is directly connected to networked device 110 through serial port 216.

If the enabling module determines that the source of the disable request is not connected over a physically secure network connection, then, at step 515, the disable request is denied. After denial of the request, method 500 terminates.

However, if the enabling module determines that the source of the disable request is connected over a physically secure network connection, then method 500 proceeds to step 520. At step 520, the enabling module issues a command to disable the control module. In an embodiment where the control module is an SSH daemon (such as SSHD 114 in FIGS. 1 and 2), and the operating system that executes on the networked device is the Unix or Linux operating system (i.e., OS 112 in FIGS. 1 and 2 is either Unix or Linux), then, at step 520, the enabling module issues the Unix “kill” command, specifying the process ID of the running SSH daemon as a parameter.

After disabling the control module at step 520, method 500 proceeds to step 525. At step 525, the enabling module receives a request to re-enable the control module. Next, at step 530, the enabling module determines whether the request to re-enable the control module is received from a source that is connected to the enabling module over a physically secure network connection. The enabling module makes the determination in step 530 in much the same manner as it makes the determination of whether the initial disable request is received from a source connected over a physically secure network connection (i.e., at step 510 of method 500). Further, in some embodiments, in order to ensure data integrity in the password reset process, enabling module determines whether the re-enable request is received from the same source as the initial disable request is received from.

If the enabling module determines that the source of the re-enable request is not connected over a physically secure network connection, then method 500 proceeds to step 535, where the re-enable request is denied. After denial of the re-enable request, method 500 terminates.

However, if the enabling module determines that the source of the re-enable request is connected over a physically secure network connection, then method 500 proceeds to step 540. At step 540, the enabling module prompts the requestor for a password. In some embodiments, the request is transmitted as an input screen that is rendered at the requestor's computer (e.g., computer 120 in FIG. 1, or console 210 in FIG. 2). Next, method 500 proceeds to step 545, where a password is received from the requestor and stored at the networked device. As was the case for the initial enablement of a control module (illustrated as method 300 in FIG. 3), embodiments of the enabling module are configured to check the received password in order to verify that the password complies with password rules. Further, in embodiments, the received password is stored in the networked device using the password facilities provided by the operating system running on the networked device. For example, on Linux systems, the received password is stored in a shadow password file using the Linux password facilities.

Once the new password has been received and stored at step 545, method 500 proceeds to step 550, where the control module is re-enabled. In embodiments, re-enabling of the control module consists of starting a daemon process. For example, in the embodiments illustrated in FIGS. 1 and 2, the control module is the SSH daemon (i.e., SSHD 114) and re-enabling of the SSH daemon entails starting a thread for that process. Once the SSH daemon is running (and accepting connections, typically, on port 22), end users may then connect to the networked device via a secure shell session over an unsecure network. For example, users accessing control device 160 may connect to networked device 110 over Internet 150 using a secure shell session.

Finally, after step 550, method 500 terminates.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Many variations, modifications, additions, and improvements are possible. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A networked device, comprising:
a network interface;
a control module; and
an enabling module configured to:
detect a request to enable the control module; and
in response to detecting the request and determining that the request is received through a physically secure channel, enable the control module and set up credentials for accessing the control module.

2. The networked device of claim 1, wherein the enabling module is further configured to determine a source of the request.

3. The networked device of claim 2, wherein the step of determining that the request is received through a physically secure channel comprises determining that the source of the request is connected to the networked device over the physically secure channel.

4. The networked device of claim 3, wherein the step of setting up credentials for accessing the control module comprises:
issuing a prompt to create a password;
receiving a password; and
storing the password.

5. The networked device of claim 2, wherein the physically secure channel is a local area network connection.

6. The networked device of claim 2, wherein the physically secure channel is a serial port connection.

7. The networked device of claim 1, wherein the control module is a secure shell daemon.

8. The networked device of claim 7, wherein the enabling of the control module comprises:
enabling a login account for the network device; and
starting the secure shell daemon.

9. A method of enabling a control module of a networked device, the method comprising:
detecting a request to enable the control module; and
in response to detecting the request,
determining that the request is received through a physically secure channel;
setting up credentials for accessing the control module; and
enabling the control module.

10. The method of claim 9, further comprising determining a source of the request.

11. The method of claim 10, wherein the step of determining that the request is received through a physically secure channel comprises determining that the source of the request is connected to the networked device over the physically secure channel.

12. The method of claim 11, wherein the step of setting up credentials for accessing the control module comprises:
issuing a prompt to create a password;
receiving a password; and
storing the password.

13. The method of claim 11, wherein the physically secure channel is a local area network connection.

14. The method of claim 11, wherein the physically secure channel is a serial port connection.

15. The method of claim 10, wherein the control module is a secure shell daemon.

16. The method of claim 15, wherein the step of enabling the control module comprises:
enabling a login account of the networked device; and
starting the secure shell daemon.

17. A method of resetting a password for a control module that is enabled for a networked device, the method comprising:
detecting a request to disable the control module;
determining that the request is received through a physically secure channel;
disabling the control module;
detecting a request to enable the control module;
issuing a prompt to create a new password for the control module;
receiving and storing the new password; and
enabling the control module.

18. The method of claim 17, further comprising determining a source of the request to disable the control module.

19. The method of claim 18, wherein the step of determining that the request is received through a physically secure channel comprises determining the source of the request is connected to the network device over the physically secure channel.

20. The method of claim 17, wherein the control module is a secure shell daemon.
